(19) United States
(12) Patent Application Publication
(10) Pub. No.: US 2021/0073479 A1
(43) Pub. Date: Mar. 11, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Ryohei Yamada, Kanagawa (JP)

(73) Assignee: FUJI XEROX CO., LTD., Tokyo (JP)

(21) Appl. No.: 16/821,100

(22) Filed: Mar. 17, 2020

(30) Foreign Application Priority Data
Sep. 10, 2019 (JP) 2019-164658

(51) Int. Cl. G06F 40/58; G06F 40/279; G06K 9/32; G06F 9/54

(52) U.S. Cl. CPC G06F 40/58; G06F 9/542; G06K 9/3266; G06F 40/279

(57) ABSTRACT

An information processing apparatus includes a processor programmed to: acquire from a video a first subtitle in a first language, translate the first subtitle in the first language into a second subtitle in a second language, and display a notification for the second subtitle in a case where a display time for the first subtitle in the first language is shorter than a recognition time for the second subtitle in the second language.

### CROSS-REFERENCE TO RELATED APPLICATIONS

This application is based on and claims priority under 35 USC 119 from Japanese Patent Application No. 2019-164658 filed Sep. 10, 2019.

### BACKGROUND

### (i) Technical Field

The present disclosure relates to an information processing apparatus and a non-transitory computer readable medium.

### (ii) Related Art

In Japanese Unexamined Patent Application Publication No. 2009-164969, a content playback apparatus that plays back video content with a structure in which additional information and a video are associated with each other through a playback time to display both the additional information and the video on a display device is disclosed. The content playback apparatus includes playback time calculating means for calculating, as a playback time of additional information in video content, at least part of the time from a playback time of the additional information to a playback time of the next additional information, playback speed control means for setting, as a playback speed for displaying the additional information and the video associated with the additional information, the ratio of the playback time to the time required for a viewer to view the additional information, and display control means for causing the additional information and the video associated with the additional information to be displayed on the display device at the playback speed.

In Japanese Unexamined Patent Application Publication No. 2009-16910, a video playback apparatus that plays back at least video data and subtitle data from a recording medium including the video data, audio data, and the subtitle data is disclosed. In the video playback apparatus, the subtitle data is extracted, the language of the extracted subtitle data is translated into another language, and subtitle data in the translated language is played back along with the video data.

### SUMMARY

In translating a subtitle on a video and displaying the translated subtitle, if a subtitle display time associated with the original subtitle before translation is applied to the translated subtitle, the subtitle display time may be shorter than a recognition time required to recognize the translated subtitle. For example, the number of letters in the translated subtitle may be larger than the number of letters in the original subtitle. In this case, a user is not able to recognize the translated subtitle correctly. To prevent this, for example, in the case where a video with a subtitle is translated and there is a part in which a display time for displaying the subtitle is shorter than a recognition time required to recognize the translated subtitle, the part is specified in advance and adjustment such as editing the video is performed for the part. Thus, before the video with the translated subtitle is played back, a user needs to understand the part in which the display time is shorter than the recognition time.

Aspects of non-limiting embodiments of the present disclosure relate to providing an information processing apparatus and a non-transitory computer readable medium that are capable of allowing, in the case where a subtitle on a video is translated and displayed, a user to understand, before the video with the translated subtitle is played back, that there is a part in which a display time associated with the subtitle is shorter than a recognition time required to recognize the translated subtitle.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus comprising a processor programmed to acquire from a video a first subtitle in a first language, translate the first subtitle in the first language into a second subtitle in a second language, and display a notification for the second subtitle in a case where a display time for the first subtitle in the first language is shorter than a recognition time for the second subtitle in the second language.

### BRIEF DESCRIPTION OF THE DRAWINGS

Exemplary embodiments of the present disclosure will be described in detail based on the following figures, wherein:

FIG. 1 is a system diagram illustrating a configuration of a multimedia content generation system according to an exemplary embodiment of the present disclosure;

FIG. 2 is a block diagram illustrating a hardware configuration of an editing processing server according to an exemplary embodiment of the present disclosure;

FIG. 3 is a block diagram illustrating a functional configuration of an editing processing server according to an exemplary embodiment of the present disclosure;

FIG. 4 is a flowchart schematically illustrating a process of an editing processing server according to an exemplary embodiment of the present disclosure;

FIGS. 5A and 5B are diagrams for schematically explaining a process of an editing processing server according to an exemplary embodiment of the present disclosure;

FIG. 6 is a diagram illustrating a section of a video captured into the editing processing server;

FIG. 7 is a diagram illustrating an example of a translation display screen for the video illustrated in FIG. 6;

FIG. 8 is a diagram illustrating a section of a video captured into the editing processing server;

FIG. 9 is a diagram illustrating an example of a translation display screen for the video illustrated in FIG. 8;

FIG. 10 is a diagram illustrating an example of a priority setting screen for the case where a subtitle recognition time is shorter than a subtitle display time;

FIG. 11 is a diagram illustrating an example of a translation display screen for the video illustrated in FIG. 8;

FIG. 12 is a diagram illustrating a section of a video captured into the editing processing server;

FIGS. 13A and 13B are diagrams for schematically explaining a process of an editing processing server according to an exemplary embodiment of the present disclosure;

FIG. 14 is a diagram illustrating an example of a translation display screen for the video illustrated in FIG. 12;

FIG. 15 is a diagram illustrating an example of a priority setting screen for the case where a subtitle recognition time is shorter than a subtitle display time;

FIG. 16 is a diagram illustrating an example of a translation display screen for the video illustrated in FIG. 12; and

FIGS. 17A and 17B are diagrams illustrating an example of a display screen for notifying of a part of a video in which a subtitle recognition time is shorter than a subtitle display time.

### DETAILED DESCRIPTION

Exemplary embodiments of the present disclosure will be described in detail with reference to drawings.

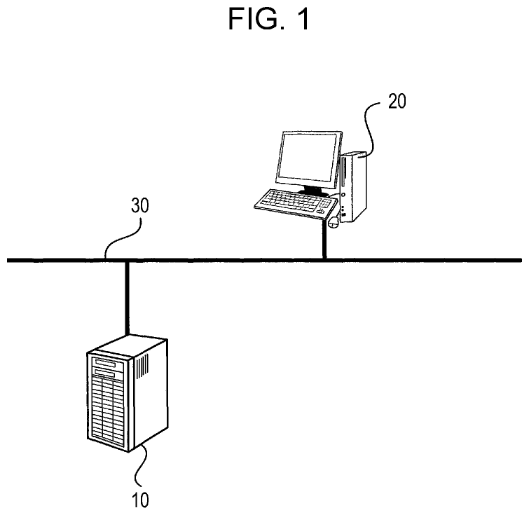

FIG. 1 is a system diagram illustrating a configuration of a multimedia content generation system according to an exemplary embodiment of the present disclosure.

A multimedia content generation system according to an exemplary embodiment of the present disclosure includes, as illustrated in FIG. 1, an editing processing server 10 and a terminal apparatus 20 such as a personal computer (hereinafter, abbreviated as a PC) that are connected with each other via a network 30.

The multimedia content generation system according to this exemplary embodiment generates multimedia content, which is a combination of various types of content such as videos, still images, sounds, characters, automatic translation, and the like. The multimedia content generation system according to this exemplary embodiment is able to generate, for example, multimedia content in which a subtitle is added to a video, the added subtitle is translated into a different language, and the translated subtitle is added to the video.

A subtitle mentioned herein represents information such as a commentary, conversation, or translation displayed as text on a screen of a video such as a movie or television. Such a subtitle may be transferred as subtitle information between the terminal apparatus 20 and the editing processing server 10.

The editing processing server 10 is an information processing apparatus into which editing software for editing various types of content to generate multimedia content is installed. The terminal apparatus 20 captures a video and generates multimedia content using the editing software running on the editing processing server 10.

Such editing software may not be installed in the editing processing server 10 but may be directly installed in the terminal apparatus 20 such as a PC and used.

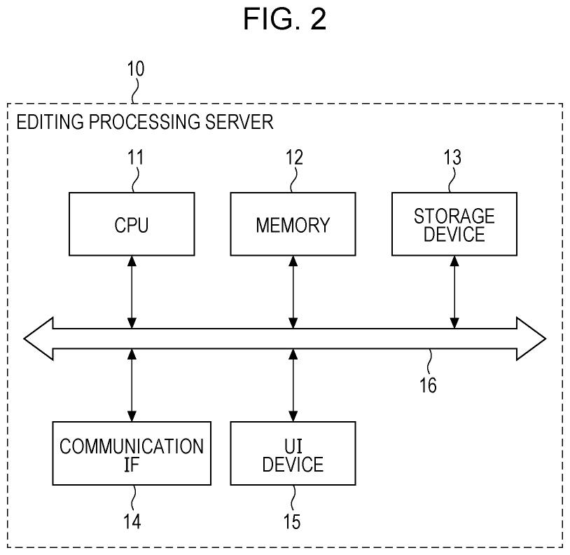

FIG. 2 illustrates a hardware configuration of the editing processing server 10 in the multimedia content generation system according to this exemplary embodiment.

The editing processing server 10 includes, as illustrated in FIG. 2, a central processing unit (CPU) 11, a memory 12, a storage device 13 such as a hard disk drive (HDD), a communication interface (IF) 14 that transmits and receives data to and from an external apparatus such as the terminal apparatus 20 via the network 30, and a user interface (UI) device 15 including a touch panel or a liquid crystal display and a keyboard. The above-mentioned components are connected with each other via a control bus 16.

The CPU 11 performs predetermined processing based on a control program stored in the memory 12 or the storage device 13 to control an operation of the editing processing server 10. In this exemplary embodiment, explanation will be provided based on the assumption that the CPU 11 reads and executes the control program stored in the memory 12 or the storage device 13. However, the program may be stored in a recording medium such as a compact disc-read only memory (CD-ROM) and provided to the CPU 11.

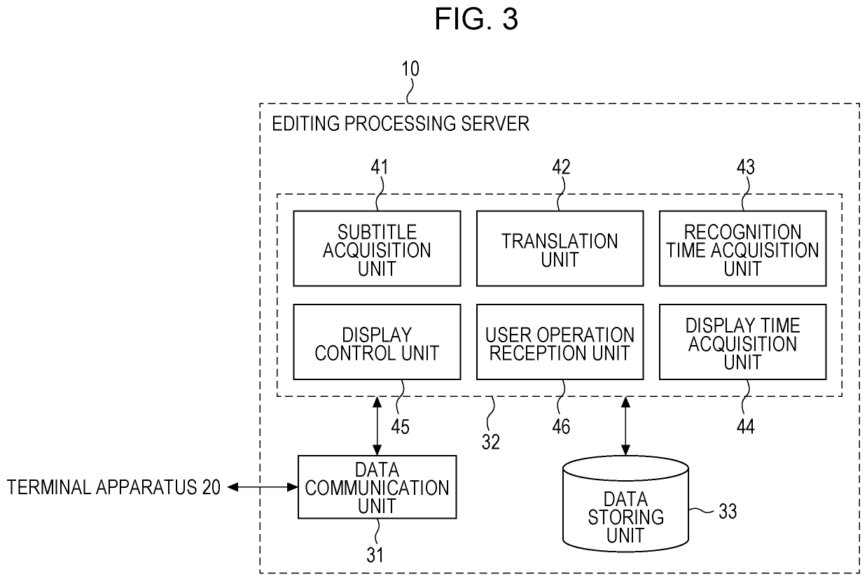

FIG. 3 is a block diagram illustrating a functional configuration of the editing processing server 10 implemented by execution of the control program.

The editing processing server 10 according to this exemplary embodiment includes, as illustrated in FIG. 3, a data communication unit 31, a controller 32, and a data storing unit 33.

The data communication unit 31 performs data communication with the terminal apparatus 20 via the network 30.

The controller 32 controls an operation of the editing processing server 10. The controller 32 includes a subtitle acquisition unit 41, a translation unit 42, a recognition time acquisition unit 43, a display time acquisition unit 44, a display control unit 45, and a user operation reception unit 46.

The data storing unit 33 stores various content data including video data on which editing processing is to be performed. The data storing unit 33 also stores a table indicating, for each language, the number of letters or the number of words in a subtitle that are able to be recognized per unit time.

The display control unit 45 controls screens displayed on the terminal apparatus 20.

The subtitle acquisition unit 41 acquires a subtitle in a first language from a video to which the subtitle is added.

The translation unit 42 translates the subtitle in the first language into a second language.

The display time acquisition unit 44 acquires a subtitle display time, which is a time in which the subtitle in the first language is displayed. Specifically, the display time acquisition unit 44 acquires, as the subtitle display time, a time from the display start time at which displaying the subtitle starts to the display end time at which displaying the subtitle ends.

Furthermore, in a case where a plurality of subtitles in the first language whose display times overlap at least partially are displayed in a section (also called a scene), which is a section of a video, the display time acquisition unit 44 acquires, as the subtitle display time, a time from the display start time at which displaying the first subtitle displayed out of the plurality of subtitles starts to the display end time at which displaying the last subtitle displayed out of the plurality of subtitles ends.

The recognition time acquisition unit 43 acquires a subtitle recognition time, which is a time required to recognize a subtitle in the second language obtained by translation by the translation unit 42.

The subtitle recognition time represents a time required to recognize a subtitle in the second language obtained by translation by the translation unit 42. In this example, the subtitle recognition time is a time required to read a subtitle and is calculated based on the number of letters or the number of words for each language. That is, the recognition time acquisition unit 43 acquires the subtitle recognition time based on the number of letters or the number of words in a translated subtitle in the second language. The subtitle recognition time may be set to be different according to the language.

Furthermore, in the case where a plurality of subtitles in the first language whose display times overlap at least partially are displayed in a section of a video, the recognition time acquisition unit 43 sums a plurality of subtitle recognition times for the second language after translation in the section of the video to obtain the subtitle recognition time.

In the case where the subtitle display time for the first language is shorter than the subtitle recognition time for the second language translated by the translation unit 42, the display control unit 45 functions as notifying means for displaying and notifying of a corresponding part.

Furthermore, the display control unit 45 performs control such that a still image at the display start time in a section in which the subtitle display time for the first language acquired by the subtitle acquisition unit 41 is shorter than the subtitle recognition time for the second language translated by the translation unit 42 is displayed, and notifies of a corresponding part.

Furthermore, the display control unit 45 performs control such that a section in which the subtitle display time for the first language acquired by the subtitle acquisition unit 41 is shorter than the subtitle recognition time for the second language translated by the translation unit 42 is repeatedly played back and displayed, and notifies of a corresponding part.

Furthermore, the display control unit 45 performs control such that a playback section in which the subtitle display time for the first language acquired by the subtitle acquisition unit 41 is shorter than the subtitle recognition time for the second language translated by the translation unit 42 is displayed in a display form different from other sections, and notifies of a corresponding part.

Furthermore, the display control unit 45 performs control such that a playback section in which the subtitle display time for the first language acquired by the subtitle acquisition unit 41 is shorter than the subtitle recognition time for the second language translated by the translation unit 42 is displayed in different forms between the case where the ratio of the subtitle display time for the first language to the subtitle recognition time for the second language is lower than a preset value and the case where the ratio of the subtitle display time for the first language to the subtitle recognition time for the second language is equal to or higher than the preset value, and notifies of a corresponding portion.

In the case where the subtitle display time for the subtitle in the first language is shorter than the subtitle recognition time for the second language, the translation unit 42 translates part of the subtitle in the first language into the second language. For example, in the case where the subtitle display time for the first language is shorter than the subtitle recognition time for the second language, the translation unit 42 translates part of words in the subtitle in the first language into the second language.

Furthermore, in the case where a subtitle in the first language is displayed in a section of a video, the translation unit 42 translates part of words in the subtitle.

Furthermore, in the case where a plurality of subtitles in the first language are displayed in a section of a video and the subtitle display time for the first language is shorter than the subtitle recognition time for the second language, the translation unit 42 translates any one of the plurality of subtitles in the first language into the second language.

Furthermore, the translation unit 42 translates part of a subtitle in the first language into the second language, based on a predetermined priority order, such that the subtitle recognition time for the translated second language is shorter than the subtitle display time for the original first language before translation.

Specifically, the translation unit 42 translates part of a subtitle in the first language into the second language, based on a priority order corresponding to an arrangement position of the subtitle in the first language in a video. Furthermore, the translation unit 42 preferentially translates a subtitle whose display form is different from other subtitles in a video, such as a subtitle in which the size of letters is different from those in other subtitles or a subtitle in which the color of letters is different from those in other subtitles.

The user operation reception unit 46 receives a priority order for a subtitle to be translated into the second language, out of subtitles in the first language acquired by the subtitle acquisition unit 41. Then, the translation unit 42 translates part of a subtitle in the first language into the second language, based on the priority order received by the user operation reception unit 46.

Next, an operation of the editing processing server 10 in the multimedia content generation system according to this exemplary embodiment will be described in detail with reference to drawings.

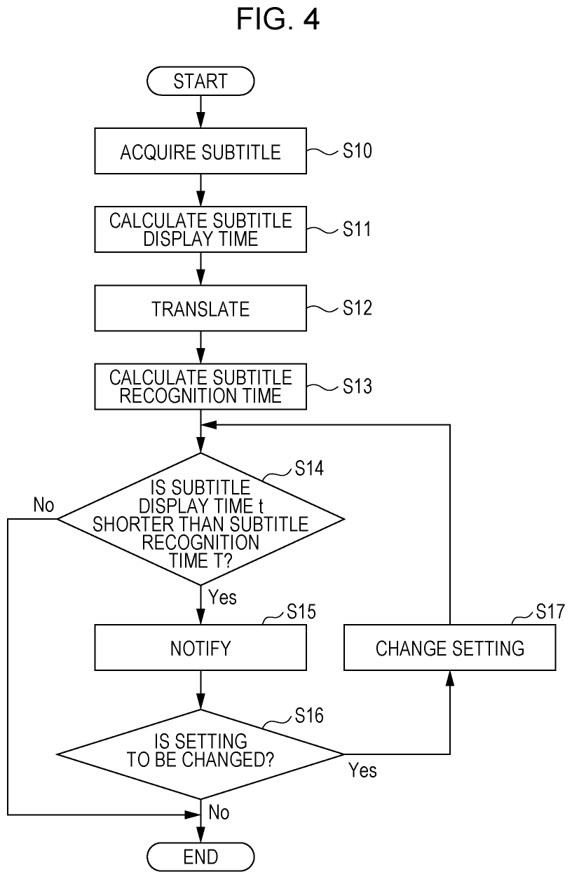

First, an operation of the editing processing server 10 will be schematically explained with reference to a flowchart of FIG. 4. An example in which a subtitle in Japanese as a first language is translated into English as a second language will be explained below. In the data storing unit 33, information of a subtitle recognition time indicating that five letters in a Japanese subtitle is able to be recognized per second and information of a subtitle recognition time indicating that two words in an English subtitle is able to be recognized per second, are stored.

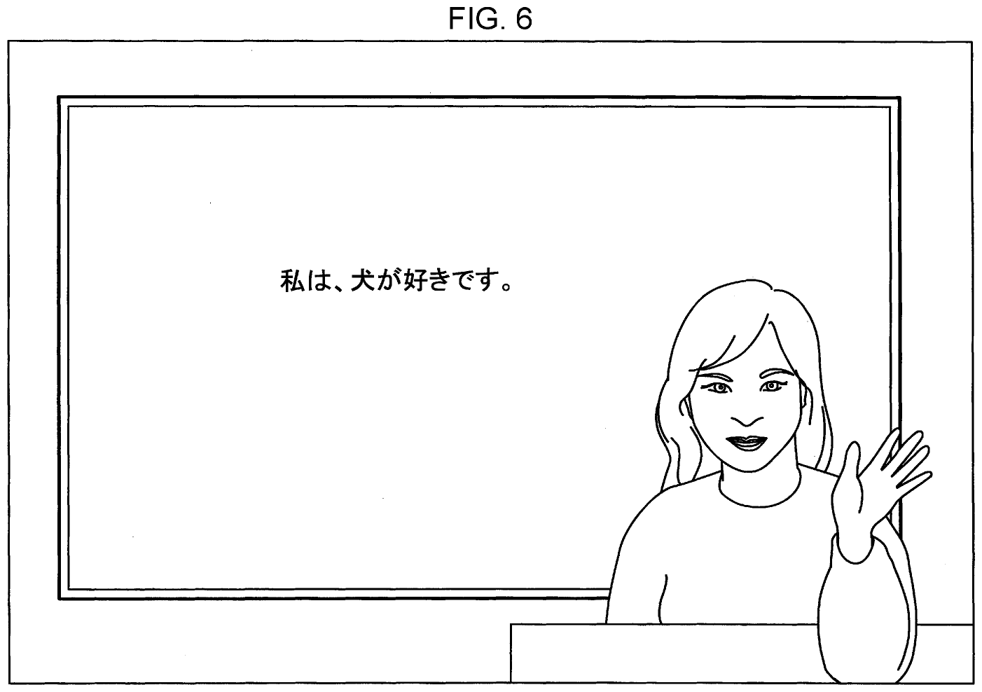

First, in step S10, the subtitle acquisition unit 41 acquires a subtitle added to a video. Specifically, a Japanese subtitle illustrated in FIG. 6 is acquired from a video with the Japanese subtitle.

In step S11, the display time acquisition unit 44 acquires a subtitle display time t for the subtitle acquired in step S10. The subtitle display time t represents a time from a subtitle display start time at which displaying a subtitle starts to a subtitle display end time at which displaying the subtitle ends. Furthermore, the subtitle display time t is set based on the table stored in the data storing unit 33. Specifically, in the case where the number of letters in a Japanese subtitle is 10, as illustrated in FIG. 6, the subtitle display time t is set to 2 seconds.

In step S12, the translation unit 42 translates the Japanese subtitle acquired in step S10 into English. Specifically, the translation unit 42 translates the Japanese subtitle into an English subtitle “I like dogs.”.

In step S13, the recognition time acquisition unit 43 counts the number of translated English letters or the number of translated English words, and calculates the subtitle recognition time based on the number of letters or the number of words for English in the table stored in the data storing unit 33. Specifically, the recognition time acquisition unit 43 counts the number of translated English words as 3, and thus calculates the subtitle recognition time T as 1.5 seconds.

In step S14, the controller 32 determines whether the subtitle display time t is longer than the subtitle recognition time T.

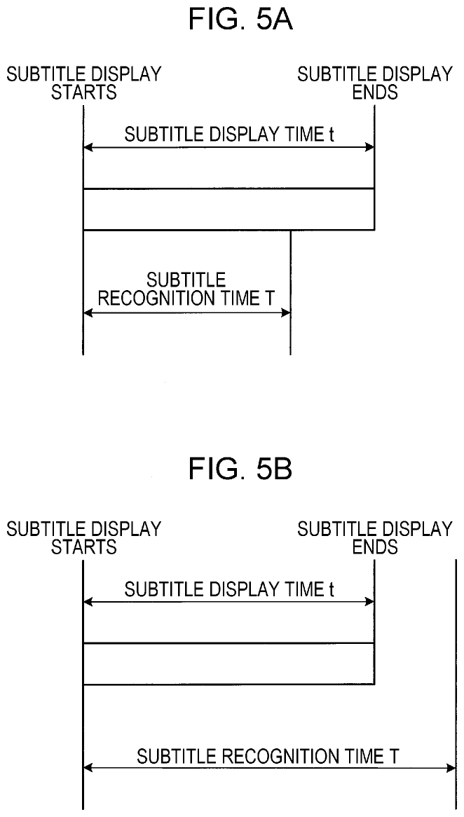

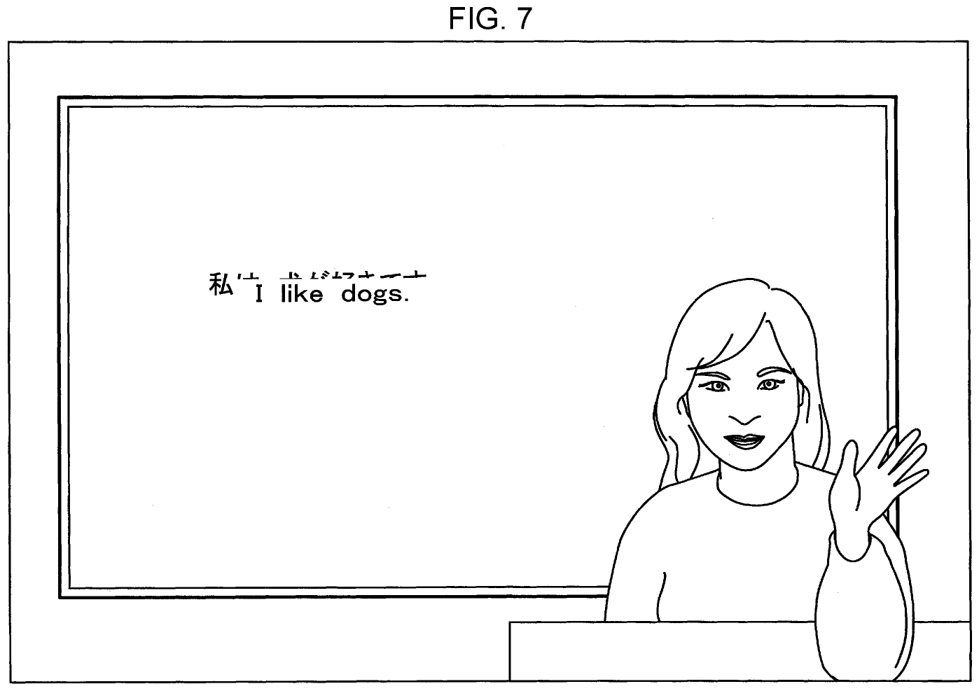

In the case where, as illustrated in FIG. 5A, it is determined in step S14 that the subtitle display time t is longer than the subtitle recognition time T, the process ends, and the translated English subtitle is displayed on the Japanese subtitle. Specifically, the subtitle display time t for the Japanese subtitle is set to 2 seconds. The number of words in the English subtitle “I like dogs. ” is counted as 3, and the subtitle recognition time T is thus calculated as 1.5 seconds. Thus, the subtitle display time t is longer than the subtitle recognition time T, and the English subtitle “I like dogs. ” is displayed on the Japanese subtitle in the video, as illustrated in FIG. 7. That is, it is determined that the subtitle display time t is long enough to recognize the translated English subtitle. Accordingly, a user does not need to extend the display time for the translated English subtitle.

In contrast, in the case where, as illustrated in FIG. 5B, it is determined in step S14 that the subtitle display time t is shorter than the subtitle recognition time T, the display control unit 45 performs control such that a still image at the display start time of a section in which the subtitle display time for the first language acquired by the subtitle acquisition unit 41 is shorter than the subtitle recognition time for the second language translated by the translation unit 42 is displayed, and notifies of a corresponding position in step S15.

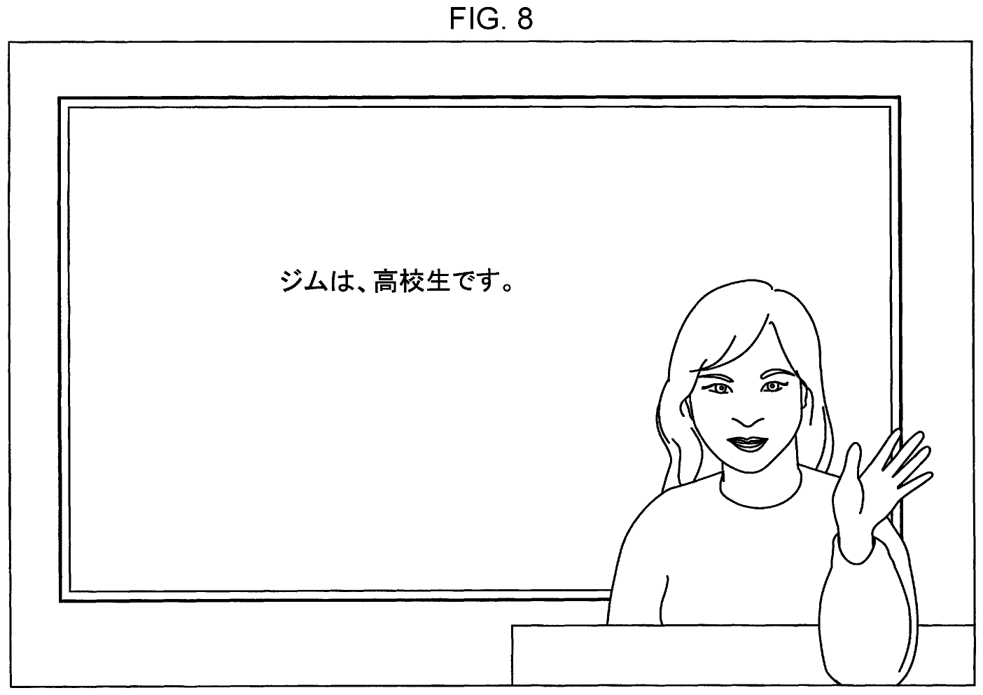

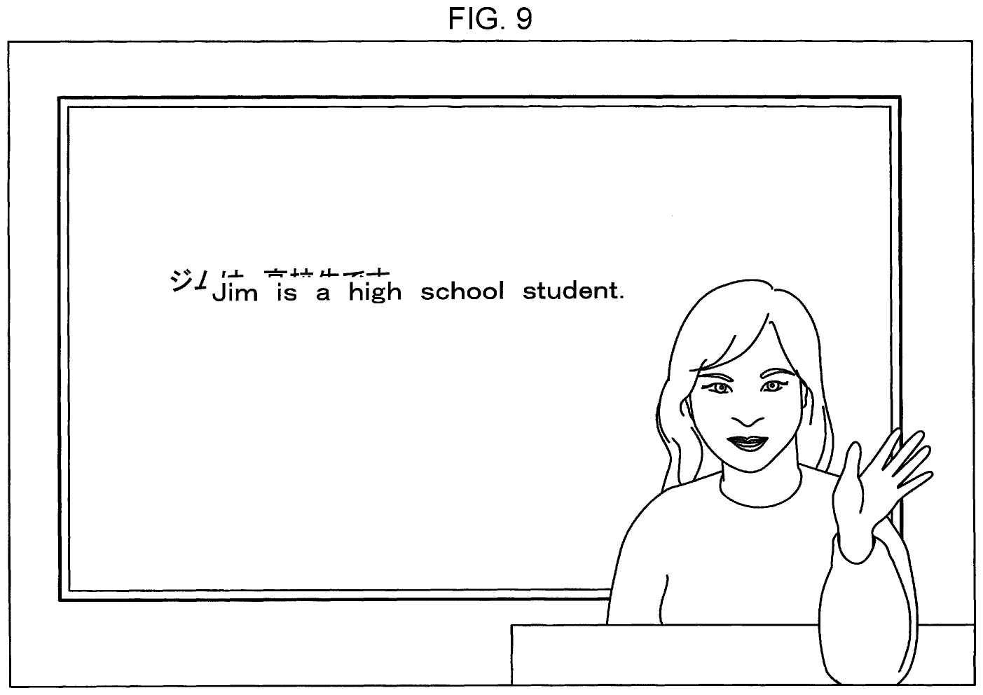

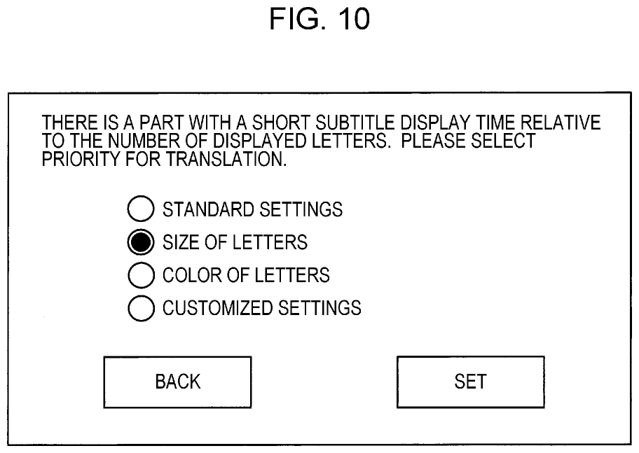

Specifically, for example, in a section of a video illustrated in FIG. 8, the subtitle display time t for a Japanese subtitle is set to 2.2 seconds. The number of words in an English subtitle “Jim is a high school student.” is 6, and the subtitle recognition time T is thus calculated as 3 seconds. The subtitle display time t is shorter than the subtitle recognition time T. Therefore, on the display screen of the terminal apparatus 20, a still image at the display start time of a corresponding part illustrated in FIG. 9 and a priority setting screen illustrated in FIG. 10 are displayed. At this time, the entire translated subtitle in this section is displayed in the still image. That is, it is determined that the subtitle display time t is not long enough to recognize the translated English subtitle, and a user needs to select priority for translation between extension of the display time for the translated English subtitle and translation of part of the subtitle.

As illustrated in FIG. 10, the display screen of the terminal apparatus 20 notifies that the video includes a part with a short subtitle display time, and the priority setting screen for selection of priority for translation is displayed. As the priority for translation, standard settings, settings corresponding to the display form of letters such as the size and color of letters, and customized settings, which will be described later, are displayed such that selection between the above settings may be made.

The standard settings represents settings corresponding to the position in which a subtitle is displayed. In the case where the “standard settings” is selected on the priority setting screen illustrated in FIG. 10, for example, the translation unit 42 performs translation by, where an upper left position on the screen is represented by (x,y)=(0,0), giving priority to a case where the value of y is smaller and giving priority to a case where the value of x is smaller if the value of y is the same.

Furthermore, in the case where “size of letters” is selected on the priority setting screen illustrated in FIG. 10, the translation unit 42 performs translation by giving priority to a character string with a large pointer, which represents the size of letters. Furthermore, in the case where letters to be translated have the same point, the translation unit 42 performs translation according to the standard settings.

Furthermore, in the case where “color of letters” is selected on the priority setting screen illustrated in FIG. 10, the translation unit 42 performs translation by giving priority to a character string in a specified color. Furthermore, in the case where letters to be translated are in the same color, the translation unit 42 performs translation according to the standard settings.

Furthermore, in the case where “customized settings” is selected on the priority setting screen illustrated in FIG. 10, the translation unit 42 performs translation by giving priority to a part in a specified translation range of a Japanese subtitle in the video.

In step S16, for example, any one of the buttons on the priority setting screen illustrated in FIG. 10 is selected, and a “set” button is pressed. Then, in step S17, change to the selected setting is performed, and the process returns to the processing of step S14.

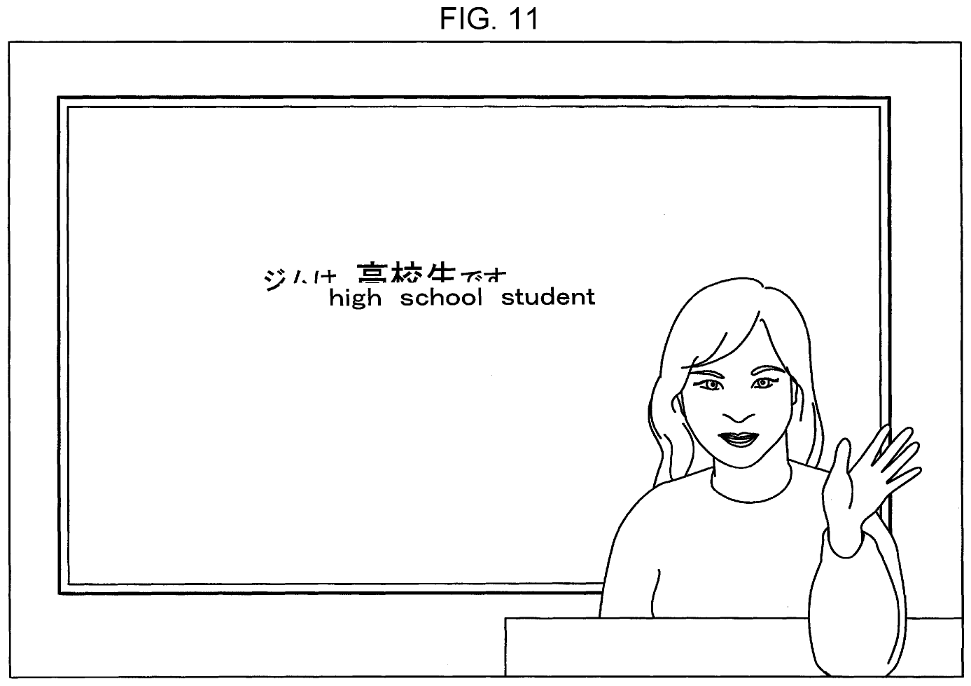

Specifically, for example, when “size of letters” is selected and the “set” button is pressed on the priority setting screen illustrated in FIG. 10, an English subtitle “high school student” is displayed on a subtitle with a size of letters larger than other letters in a Japanese subtitle, as illustrated in FIG. 11. That is, the translation unit 42 translates part of words in the Japanese subtitle into English. Thus, the number of translated English words becomes three, and the subtitle recognition time T becomes 1.5 seconds. That is, the subtitle display time t becomes longer than the subtitle recognition time T, and it is thus determined that the subtitle display time t is long enough to recognize the translated English subtitle. Therefore, a user does not need to extend the display time for the translated English subtitle.

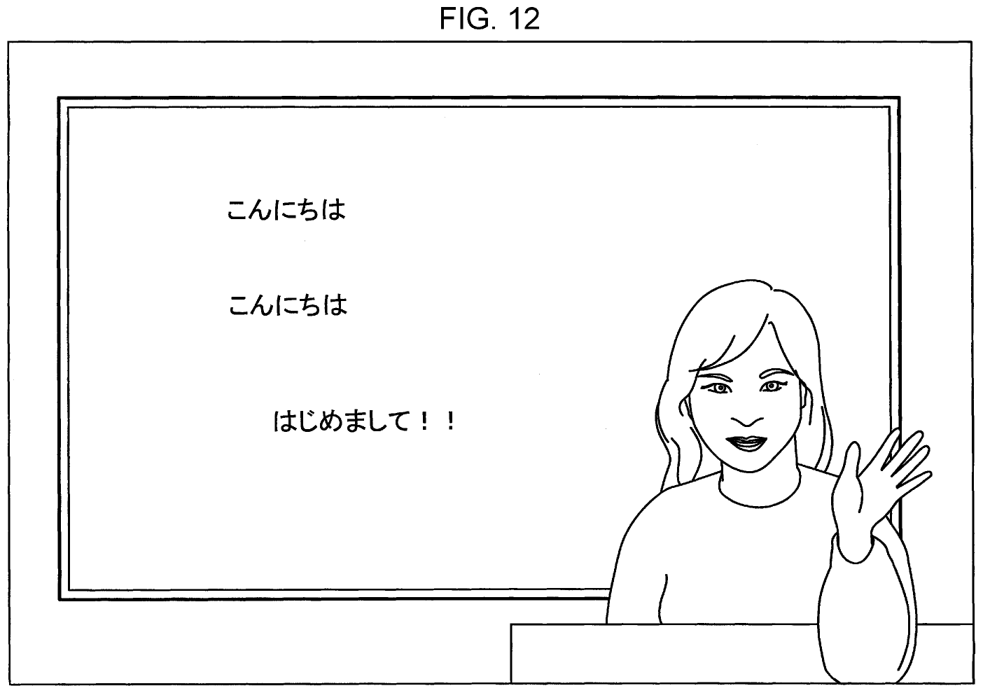

Next, a second exemplary embodiment of the present disclosure will be described. In the second exemplary embodiment, a case where display times for a plurality of Japanese subtitles overlap in a section of a video, as illustrated in FIG. 12, will be explained.

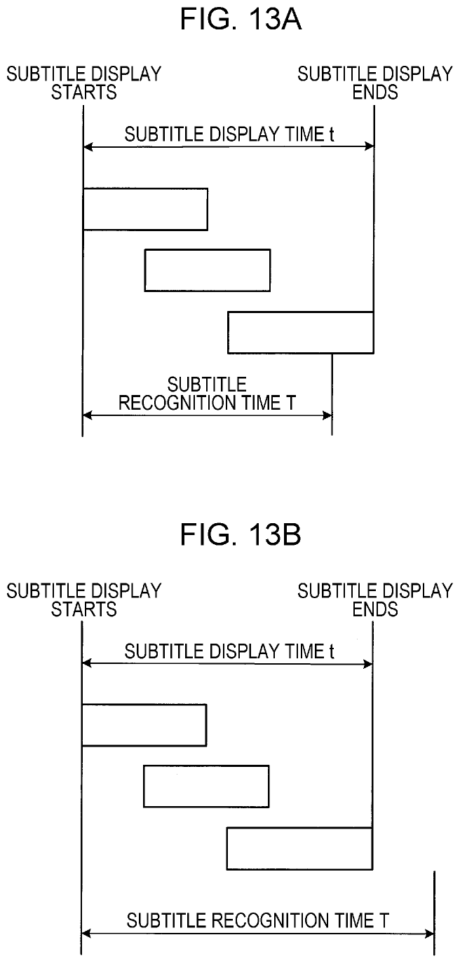

As illustrated in FIG. 12, in the case where a plurality of subtitles are added to a section of a video in an overlapping manner, the subtitle display time t represents a time from the display start time at which displaying the first subtitle displayed out of the plurality of subtitles displayed in the section starts to the display end time at which displaying the last subtitle displayed out of the plurality of subtitles displayed in the section ends, as illustrated in FIGS. 13A and 13B. That is, the display time acquisition unit 44 acquires, as the subtitle display time, the time from the display start time of the first subtitle displayed out of the plurality of subtitles to the display end time of the last subtitle displayed out of the plurality of subtitles.

Furthermore, the subtitle recognition time T is calculated by summing subtitle recognition times for the plurality of translated subtitles in the second language in the section. That is, the recognition time acquisition unit 43 calculates the subtitle recognition time by summing the plurality of subtitle recognition times for the translated second language in a section of a video.

Specifically, for example, a section of a video illustrated in FIG. 12 includes three Japanese subtitles, and a time from the display start time of the first Japanese subtitle displayed out of the three subtitles to the display end time of the last Japanese subtitle displayed is set as the subtitle display time t.

An English subtitle “Hello”, which is obtained by translating the first Japanese subtitle displayed, is one word. Thus, a subtitle recognition time T₁ is calculated as 0.5 seconds. In a similar manner, for an English subtitle obtained by translating the second Japanese subtitle displayed, a subtitle recognition time T₂ is calculated as 0.5 seconds. Furthermore, an English subtitle “Nice to meet you!!”, which is obtained by translating the last Japanese subtitle displayed, is four words. Thus, a subtitle recognition time T₃ is calculated as 2 seconds. Therefore, the subtitle recognition time T is calculated as 3 seconds by adding the subtitle recognition times T₁=0.5 seconds, T₂=0.5 seconds, and T₃=2 seconds.

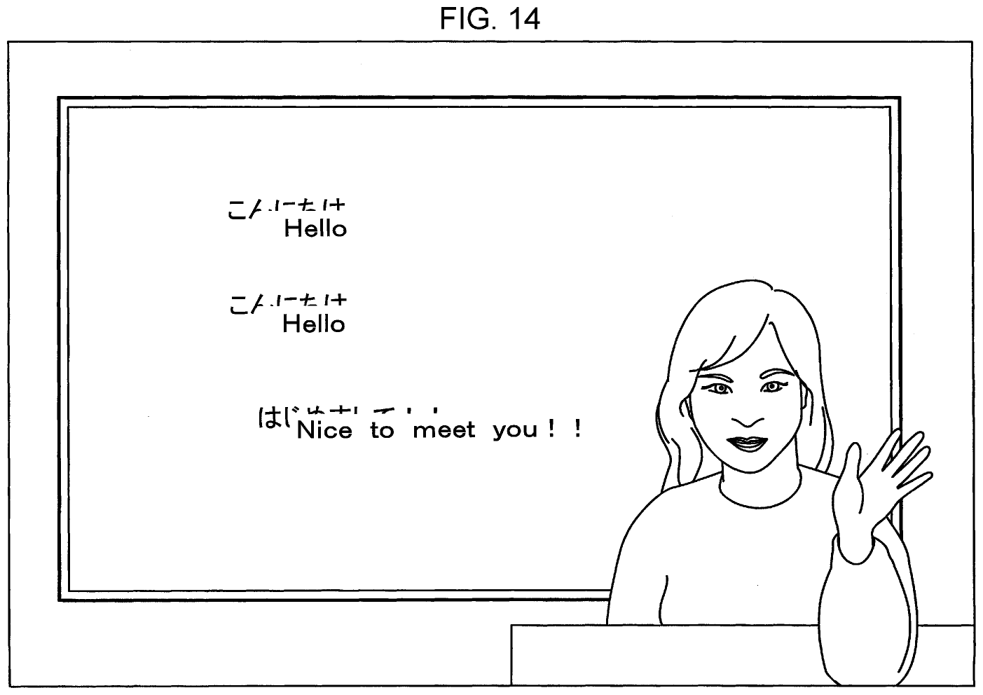

As illustrated in FIG. 13A, in the case where the subtitle display time t for the video illustrated in FIG. 12 is, for example, 5 seconds, the subtitle display time t for a plurality of subtitles in this section is longer than the subtitle recognition time T, which is 3 seconds. Therefore, translated English subtitles are displayed on three Japanese subtitles, as illustrated in FIG. 14, on the display screen of the terminal apparatus 20. That is, the subtitle display time t is longer than the subtitle recognition time T, and it is thus determined that the subtitle display time t is long enough to recognize the translated English subtitles. Therefore, there is no need to extend the display time for the translated English subtitles.

In contrast, as illustrated in FIG. 13B, in the case where the subtitle display time t for the video illustrated in FIG. 12 is, for example, 2 seconds, the subtitle display time t for the plurality of subtitles in this section is shorter than the subtitle recognition time T. Therefore, a still image at the display start time of this section and in which translated English subtitles are inserted on three Japanese subtitles illustrated in FIG. 14 is displayed, and the priority setting screen illustrated in FIG. 10 is displayed. When priority for translation is selected on the priority setting screen illustrated in FIG. 10, a subtitle with a high priority in the video is translated into English, and the translated English subtitle is displayed on a Japanese subtitle.

Next, a modification of the priority setting screen in FIG. 10 will be described.

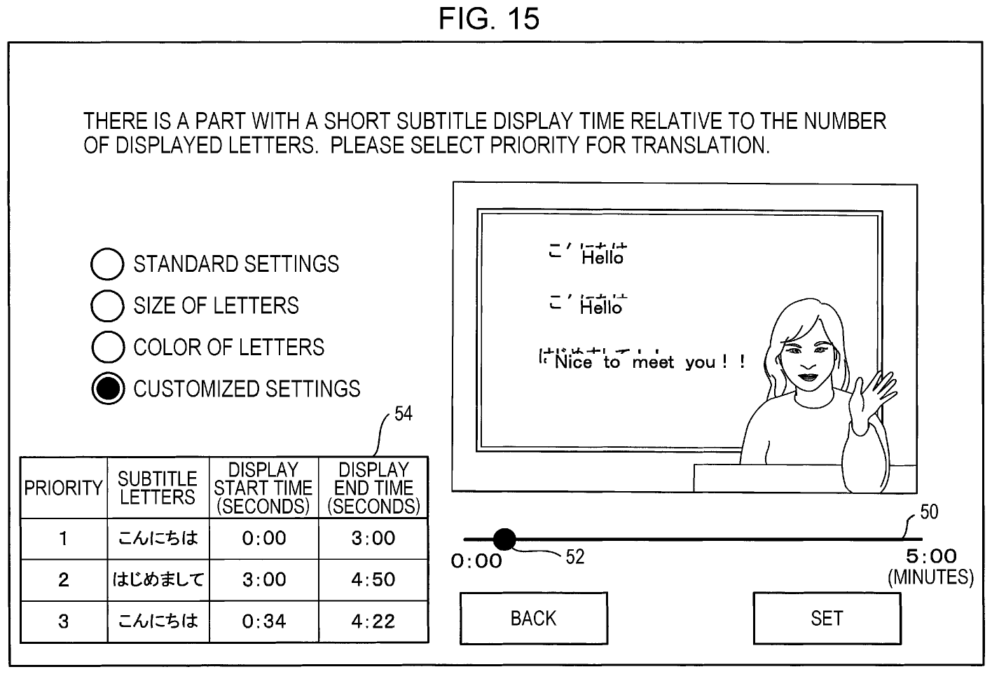

As illustrated in FIG. 15, in the case where the subtitle display time t for a video is shorter than the subtitle recognition time T, a still image at the display start time of a part of the video in which the subtitle display time t is shorter than the subtitle recognition time T is displayed. A playback switch bar 50 is displayed below the still image. By moving a pointer 52 on the playback switch bar 50, the playback position in the video is able to be switched.

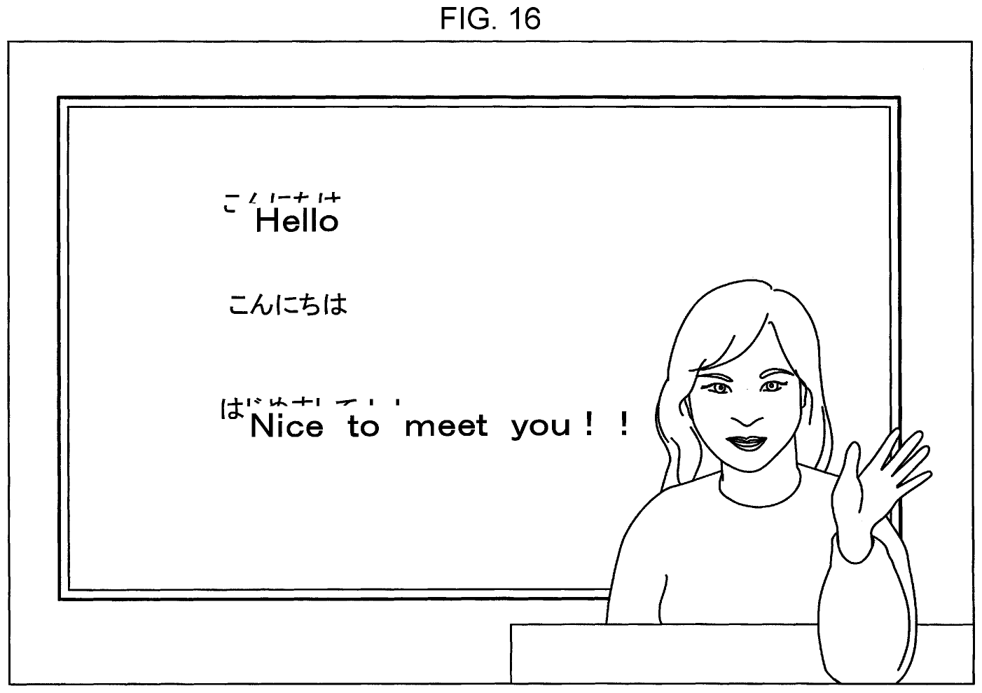

Furthermore, in the case where “customized settings” is selected on the display screen illustrated in FIG. 15, the translation unit 42 is able to preferentially translate a part of Japanese subtitles in a specified translation range in the still image. Furthermore, priority may be switched by dragging and dropping a row in a table 54 in which subtitle letters and the display start time and the display end time corresponding to the subtitle letters are displayed. When a “set” button is pressed, an English subtitle obtained by preferentially translating part of three Japanese subtitles illustrated in FIG. 16 such that the subtitle display time t is equal to the subtitle recognition time T is added and displayed on the display screen of the terminal apparatus 20.

A user is able to select a part to be preferentially translated, while confirming an image of a part in which the subtitle display time t is shorter than the subtitle recognition time T as described above.

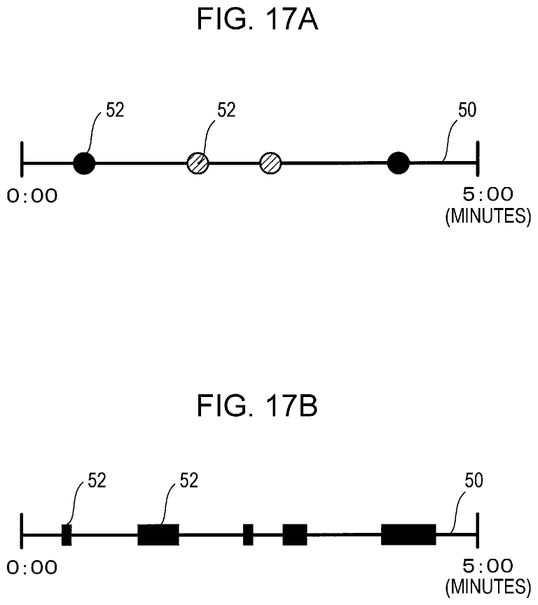

Next, the modification of the playback switch bar 50 described above will be described with reference to FIGS. 17A and 17B. In the example illustrated in FIGS. 17A and 17B, a part of a video in which the subtitle display time t is shorter than the subtitle recognition time T is displayed such that display of the pointer 52 on the playback switch bar 50 is different from other parts.

In FIGS. 17A and 17B, a part of the video in which the subtitle display time t is shorter than the subtitle recognition time T is displayed in a different manner according to the ratio of the subtitle display time t to the subtitle recognition time T.

Specifically, a part of a video in which the subtitle display time t is shorter than the subtitle recognition time T is displayed on the playback switch bar 50 in different display forms between the case where the ratio of the subtitle display time t for the first language to the subtitle recognition time T for the second language is lower than a preset value and the case where the ratio of the subtitle display time t for the first language to the subtitle recognition time T for the second language is equal to or higher than the preset value. For example, as illustrated in FIG. 17A, the pointer 52 is displayed in different colors on the playback switch bar 50 between the case where the ratio of the subtitle display time t for the first language to the subtitle recognition time T for the second language is lower than a preset value and the case where the ratio of the subtitle display time t for the first language to the subtitle recognition time T for the second language is equal to or higher than the preset value. Specifically, for example, in the case where the ratio of the subtitle display time t for the first language to the subtitle recognition time T for the second language is lower than the preset value, the pointer 52 is displayed in red, and in the case where the ratio of the subtitle display time t for the first language to the subtitle recognition time T for the second language is equal to or higher than the preset value, the pointer 52 is displayed in yellow. Furthermore, as illustrated in FIG. 17B, a part of a video in which the subtitle display time t is shorter than the subtitle recognition time T may be represented by the pointer 52, and the length of the pointer 52 on the playback switch bar 50 may be changed and displayed according to how short the subtitle display time t is compared to the subtitle recognition time T.

For selection of priority for translation, by selecting a pointer for a part with a high priority for translation from among a plurality of pointers on the playback switch bar 50 and confirming a still image in a video, the playback position of the video is able to be switched.

In this exemplary embodiment, an example in which translation is performed from Japanese as the first language into English as the second language has been explained. However, the present disclosure is not limited to this. The present disclosure is also applicable to other languages, for example, in a case where translation is performed from English as the first language into Japanese as the second language.

Furthermore, in this exemplary embodiment, an example in which a translated subtitle in the second language is displayed on the subtitle in the first language is described. However, the present disclosure is not limited to this example. A translated subtitle in the second language may be displayed in place of a subtitle in the first language.

Furthermore, in this exemplary embodiment, an example in which in the case where the subtitle display time t is shorter than the subtitle recognition time T, a still image at the display start time of a part in which the subtitle display time t is shorter than the subtitle recognition time T is displayed has been explained. However, the present disclosure is not limited to this example. Moving images in a playback section for several seconds before and after a part in which the subtitle display time t is shorter than the subtitle recognition time T may be played backed repeatedly.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor programmed to:
acquire from a video a first subtitle in a first language, translate the first subtitle in the first language into a second subtitle in a second language, and
display a notification for the second subtitle in a case where a display time for the first subtitle in the first language is shorter than a recognition time for the second subtitle in the second language.

2. The information processing apparatus according to claim 1, wherein the recognition time represents a time calculated based on a number of letters or a number of words in the second subtitle in the second language.

3. The information processing apparatus according to claim 1, wherein in a case where the display time for the first subtitle in the first language is shorter than the recognition time for the second subtitle in the second language, the processor is programmed to translate only a part of the first subtitle in the first language into the second language.

4. The information processing apparatus according to claim 2, wherein in a case where the display time for the first subtitle in the first language is shorter than the recognition time for the second subtitle in the second language, the processor is programmed to translate only part of the first subtitle in the first language into the second language.

5. The information processing apparatus according to claim 3, wherein the part is one or more words in the first subtitle.

6. The information processing apparatus according to claim 4, wherein the part is one or more words in the first subtitle.

7. The information processing apparatus according to claim 3, wherein in a case where a plurality of first subtitles in the first language are displayed in a section of the video, the part is one of the plurality of first subtitles.

8. The information processing apparatus according to claim 7,
wherein in a case where the plurality of first subtitles in the first language have display times that overlap at least partially and are displayed in the section of the video,
a time from a display start time of a first one of the plurality of first subtitles displayed to a display end time of a last one of the plurality of first subtitles displayed is defined as the display time for the first subtitle, and
the recognition time is calculated by adding recognition times for the plurality of second subtitles in the second language after translation in the section.

9. The information processing apparatus according to claim 3, wherein the processor is programmed to translate the part of the first subtitle in the first language into the second language, based on a predetermined order of priority, such that the recognition time for the second subtitle in the second language after translation becomes shorter than the display time for the first subtitle in the first language before translation.

10. The information processing apparatus according to claim 9, wherein the order of priority corresponds to a position in which the first subtitle in the first language is arranged in the video.

11. The information processing apparatus according to claim 9, wherein a first subtitle with a display form different from those of other subtitles in the video is preferentially translated.

12. The information processing apparatus according to claim 3, wherein
the processor is programmed to receive an order of priority for the first subtitle in the first language to be translated into the second language, and
translate the part of the first subtitle in the first language into the second language, based on the order of priority.

13. The information processing apparatus according to claim 1, wherein the processor is programmed to display a still image at a display start time of a section in which the display time for the first subtitle in the first language is shorter than the recognition time for the second subtitle in the second language obtained by translation.

14. The information processing apparatus according to claim 1, wherein the processor is programmed to repeatedly play back and display a section in which the display time for the first subtitle in the first language is shorter than the recognition time for the second subtitle in the second language obtained by translation.

15. The information processing apparatus according to claim 1, wherein the processor is programmed to display a playback section in which the display time for the first subtitle in the first language is shorter than the recognition time for the second subtitle in the second language obtained by translation in a display form different from those of other sections.

16. The information processing apparatus according to claim 15, wherein the processor is programmed to display the playback section in which the display time for the first subtitle in the first language is shorter than the recognition time for the second subtitle in the second language obtained by translation in different display forms between a case where a ratio of the display time for the first subtitle in the first language to the recognition time for the second subtitle in the second language is lower than a preset value and a case where the ratio of the display time for the first subtitle in the first language to the recognition time for the second subtitle in the second language is equal to or higher than the preset value.

17. A non-transitory computer readable medium storing a program causing a computer to execute a process for information processing, the process comprising:
acquiring from a video a first subtitle in a first language;
translating the first subtitle in the first language into a second subtitle in a second language; and
displaying a notification for the second subtitle in a case where a display time for the first subtitle in the first language is shorter than a recognition time for the second subtitle in the second language.

18. An information processing apparatus comprising:
acquiring means for acquiring from a video a first subtitle in a first language;
translating means for translating the first subtitle in the first language into a second subtitle in a second language; and
notifying means for displaying a notification for the second subtitle in a case where a display time for the first subtitle in the first language is shorter than a recognition time for the second subtitle in the second language.
